(19) United States
(12) Patent Application Publication
(10) Pub. No.: US 2007/0118436 A1
(43) Pub. Date: May 24, 2007

(54) Collectible holders having radio frequency identification tags and systems and methods for using the same

(76) Inventors: John C. McDowell, Atlanta, GA (US); Roger K. Nix, Florence, AL (US); Jeffrey D. Mullen, New York, NY (US)

Correspondence Address: FISH & NEAVE IP GROUP;ROPES & GRAY LLP, 1211 AVENUE OF THE AMERICAS, NEW YORK, NY, 10036-8704, US

(21) Appl. No.: 11/479,729

(22) Filed: Jun. 30, 2006

Related U.S. Application Data
(60) Provisional application No. 60/696,056, filed on Jul. 1, 2005.
(60) Provisional application No. 60/756,276, filed on Jan. 4, 2006.
(60) Provisional application No. 60/696,059, filed on Jul. 1, 2005.

(51) Int. Cl. G06Q 30/00; G07F 7/00; G06F 17/30

(52) U.S. Cl. 705/26; 705/27

(57) ABSTRACT

A collectible holder is provided. Such a holder may encapsulate a collectible and a radio frequency identification tag. Scanners may be utilized to simultaneously scan a number of RFID-enabled holders such that information about a large number of collectibles can be obtained in a short period of time. Such information can be utilized to generate an online store for a dealer, and online auction for a collection, or a virtual collectible convention that mimics a physical collectible convention.

### CROSS-REFERENCE TO RELATED APPLICATION

This application claims the benefit of U.S. Provisional Patent Application No. 60/696,056 filed on Jul. 1, 2005 and titled “Collectible Holders” (Docket No. COIN/001 PROV), Provisional Patent Application No. 60/756,276 filed on Jan. 4, 2006 and titled “Collectible Holders” (Docket No. COIN/001 PROV2) and Provisional Patent Application No. 60/696,059 filed on Jul. 1, 2005 and titled “Collectible Holders Having Radio Frequency Identification Tags And Systems And Methods For Using The Same” (Docket No. COIN/002 PROV), which are hereby incorporated by reference herein in their entirety.

### BACKGROUND OF THE INVENTION

Sportscards have been encapsulated by Professional Sports Authenticators (PSA) and coins have been encapsulated by Professional Coin Grading Service (PCGS), both of which are divisions of Collectors Universe of Newport Beach, Calif. Collectors Universe encapsulates sportscards and coins by sonically bonding two slab portions to form a slab. One slab portion is laid on top of another slab portion with the sportscard (or coin), a label, and a two-dimensional hologram being sandwiched in the middle. The label contains text in the form of the name of the sportscard (or coin) and the grade that the sportscard (or coin) received from Collector's Universe. For sportscards, this grade is a whole number between, and including, 1 and 10.

The Collectors Universe slabs are deficient in a variety of ways. For example, only a minimal amount of information is provided on the label. Additionally, as a result of the slabs simply being laid one on top of another, the structural integrity of the holder is compromised.

Moreover, the security features associated with the slabs are inadequate. For example, PSA fixes a two-dimensional hologram to the label. The label and hologram are loose inside of the slab—even after the slap portions are sonically bonded together. Thus, a person may purchase a PSA 10 1952 Topps Mickey Mantle Card for $250,000, break the card and label out of the slab, fabricate his/her own slab, and encapsulate a lesser conditioned 1952 Topps Mickey Mantle Card (e.g., a 1952 Topps Mickey Mantle Card broken out of a PSA 8 slab that cost $45,000) into the new slab with the loose label and two-dimensional hologram. The person can then send the 1952 Topps Mickey Mantle from the PSA 10 holder to PSA and have it graded and returned in a brand new PSA 10 holder. The process can be repeated infinitely—each time netting the counterfeiter a substantial profit (e.g., over $200,000).

It is therefore desirable to fabricate a collectible holder that is structurally sound, allows for enhanced information storing capabilities, and includes numerous security features to prevent counterfeiting.

### SUMMARY OF THE INVENTION

It is an object of the present invention to provide a collectible holder that is structurally sound, allows for enhanced information storing capabilities, and includes numerous security features to prevent counterfeiting.

A collectible coin holder is provided that may be configured to encapsulate a variety of collectibles such as, for example, one or more coins, stamps, currency, sportscards, autographs, photographs, books, manuscripts, sportscard wax packs, sportscard wrappers, sportscard boxes, books, or comic books. One such holder is fabricated from two holder portions. One holder portion acts as a sleeve that the other holder portion slides into. The two portions are then bonded together (e.g., ultrasonically or thermally) to provide a structurally sound holder that permanently encapsulates a collectible.

The insert portion that slides into the sleeve portion may have a trough, or opening, that is operable to receive a third holder portion (e.g., a collectible receivable portion). This third holder portion may be configured to hold any particular type of collectible (e.g., coins of various sizes, stamps, or sportscards). Thus, two of the three holder portions (e.g., a sleeve and insert portion) may be the same regardless of the type of collectible that is stored (e.g., regardless of the configuration of a collectible receivable portion).

The holder portion that acts as a sleeve and may have a ridge protruding from an exterior surface. In this manner, a trough may be cut into an opposite exterior surface, and aligned with the ridge protruding from the other side, such that such that multiple holders can be stacked together.

An RFID is included in a holder such that information about a collectible can be stored and retrieved. Such information may include, for example, descriptive information about a collectible such as the type of collectible, the specific identification number for a specific collectible by an entity, the year the collectible was made, the grade the collectible received, comments from the graders regarding the collectible, the collectible's population when encapsulated, the date of encapsulation, and any other type of information about the collectible.

As a result of the inclusion of an RFID (or a memory and transmitter) into a collectible holder, numerous advantageous systems and methods are provided. In one, a scanner is provided at the entrance to a collectible show. A dealer carries his/her inventory through this entrance such that the dealer's collectible holders communicate with the scanner. The information received by the scanner is then stored in a database, or other memory, and is attributed to the dealer. From this stored information, a virtual convention can be created and published to the web. For example, a map of the convention may be uploaded that shows the tables. A user can click on the table and receive a listing of the inventory that dealer has and the phone number of the dealer (e.g., the cell phone number). The collectible data can be categorized and also made searchable. Furthermore, data from a dealer's collectibles (or a user's collectibles) can be used to automatically form an online store for that dealer's (or user's) collectibles. Administrative tools may be provided that allow a dealer (or user) to fix a price for a collectible, put a collectible on auction, or accept offers for a collectible. Thus, a dealer does not have to enter in any product information, simply carry his/her collectible's past a scanner/receiver operable to receive the data, store the data to a database (or memory), and publish the data to a webpage in the form of an online store for that dealer.

If a holder is broken, a Graphical User Interface (GUI) is provided on a webpage such that the user can report a break and the population reports for that collectible can be updated. Additionally, an insurance feature is provided that allows a user to view his/her entire collection, receive an insurance quote for that collection, and allows the user to select and purchase insurance options.

As collectibles are graded, the collectibles are scanned from multiple perspectives (or pictures are taken from multiple perspectives). For example, tbe front and back of a coin or sportscard is scanned and stored. The scans are associated to a collectible's identification number such that anyone can view the images of any collectible. Accordingly, if a user ever desires to sell his/her collectible then the user does not have to scan or take pictures of that collectible. Moreover, an autonomous auction listing button is provided to an owner of a collectible such that a user can press the button, enter in basic auction information (e.g., minimum bid and shipping cost) and the auction will be generated (e.g., an ebay auction will automatically be started).

A display (e.g., an LCD) may also be placed in the holder. Such a display may be coupled to, for example, a memory or RFID (e.g., via a processor or other circuitry) such that information stored on such an RFID or memory may be displayed to a user. If the RFID can be written to, the information stored on the RFID may be updated (e.g., the number of a particular coin in a particular grade may be updated).

### BRIEF DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 is an illustration of a collectible holder constructed in accordance with the principles of the present invention;

FIG. 2 is an illustration of a collectible holder constructed in accordance with the principles of the present invention;

FIG. 3 is an illustration of a collectible holder constructed in accordance with the principles of the present invention;

FIG. 4 is an illustration of an RFID gateway constructed in accordance with the principles of the present invention;

FIG. 5 is an illustration of an RFID gateway constructed in accordance with the principles of the present invention;

FIG. 6 is an illustration of an RFID scanner constructed in accordance with the principles of the present invention;

FIG. 7 is an illustration of a grading process constructed in accordance with the principles of the present invention;

FIG. 8 is an illustration of a network topology constructed in accordance with the principles of the present invention;

FIG. 9 is an illustration of a collectible verification interface constructed in accordance with the principles of the present invention;

FIG. 10 is an illustration of a search results interface constructed in accordance with the principles of the present invention;

FIG. 11 is an illustration of a virtual collectibles show constructed in accordance with the principles of the present invention;

FIG. 12 is an illustration of an online store constructed in accordance with the principles of the present invention;

FIG. 13 is an illustration of an online store constructed in accordance with the principles of the present invention;

FIG. 14 is an illustration of a virtual collection constructed in accordance with the principles of the present invention;

FIG. 15 is an illustration of a best collections interface constructed in accordance with the principles of the present invention;

FIG. 16 is an illustration of a set interface constructed in accordance with the principles of the present invention;

FIG. 17 is an illustration of a population interface constructed in accordance with the principles of the present invention;

FIG. 18 is an illustration of a grade population interface constructed in accordance with the principles of the present invention;

FIG. 19 is an illustration of a submission result interface constructed in accordance with the principles of the present invention;

FIG. 20 is an illustration of a price guide interface constructed in accordance with the principles of the present invention;

FIG. 21 is an illustration of an auction interface constructed in accordance with the principles of the present invention;

FIG. 22 is an illustration of an insurance interface constructed in accordance with the principles of the present invention; and

FIG. 23 is an illustration of a reporting interface constructed in accordance with the principles of the present invention.

### DETAILED DESCRIPTION OF THE INVENTION

U.S. patent application Ser. No. ______ filed on Jun. 30, 2006 and titled “Collectible Holders” (Docket No. COIN/001), U.S. patent application Ser. No. ______ filed on Jun. 30, 2006 and titled “Holder For Collectibles” (Docket No. COIN/003A), U.S. patent application Ser. No. ______ filed on Jun. 30, 2006 and titled “Holder For Collectibles” (Docket No. COIN/003B), and U.S. patent application Ser. No. ______ filed on Jun. 30, 2006 and titled “Holder For Collectibles” (Docket No. COIN/003C) are hereby incorporated by reference herein in their entirety.

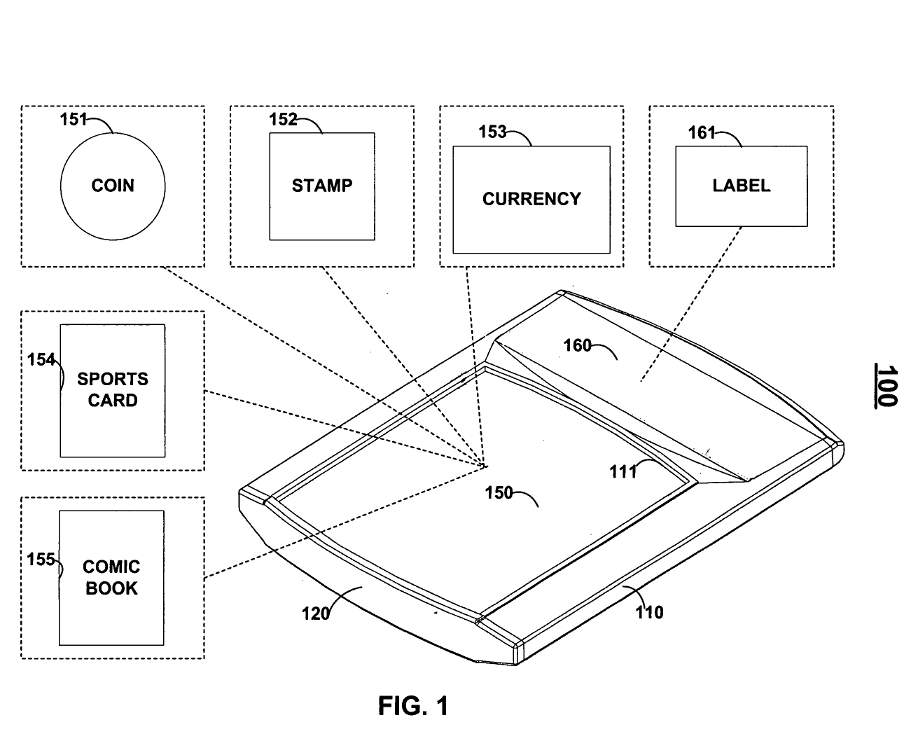

FIG. 1 shows collectible holder 100 that includes insert portion 120 that fits substantially inside of sleeve portion 110. A collectible may be stored in insert portion 120 (or a collectible receivable portion) that sits about location 150. Examples of such a collectible include comic book 155, sportscard 154, coin 151, stamp 152, and currency 153. A label may be provided on the exterior surface of sleeve portion 110 about location 160, on the interior surface of sleeve portion 110 about location 160, or on a surface of insert portion 120 (or a collectible receivable portion or component receivable portion) that aligns with location 160. Locations 150 and 160 may reside on the obverse side of holder 100 or the reverse side of holder 100.

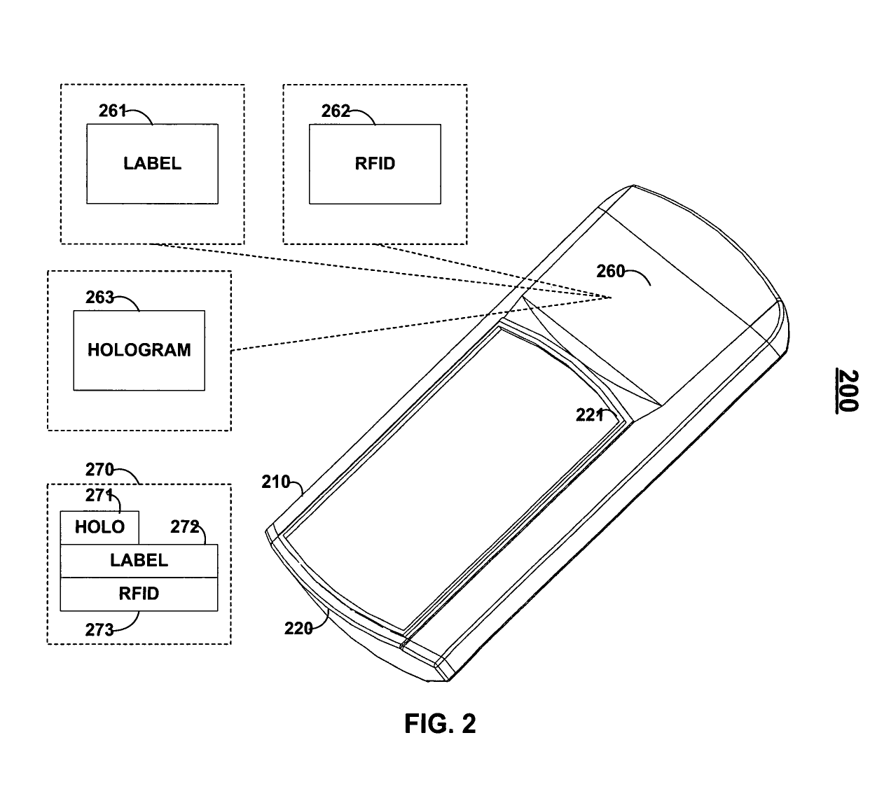

FIG. 2 shows holder 200 that includes sleeve portion 210 and insert portion 220. Insert portion 220 may include a portion to receive a collectible or a portion to receive a collectible receiving portion. Insert portion 220 may be insertable into sleeve portion 210 such that a stored collectible (e.g., stored in either insert portion or a collectible receivable portion in the insert portion) is protected by sleeve 210. A number of other components may be provided in sleeve portion 220. For example, a component may be fixed on an insert portion, a collectible receivable portion, or the interior surface of a sleeve portion. Such components may include, for example, label 261, RFID 262, Hologram 263 or any other type of component such as a memory, display screen (e.g., LCD screen), circuitry, microprocessor, transmitter, receiver, speaker, or source of power.

Hologram 263, RFID 262, and label 261 may be fixed (e.g., glued or adhered) together in any configuration. For example, configuration 270 includes hologram 271 fixed to label 272 while label 272 is fixed to RFID 273.

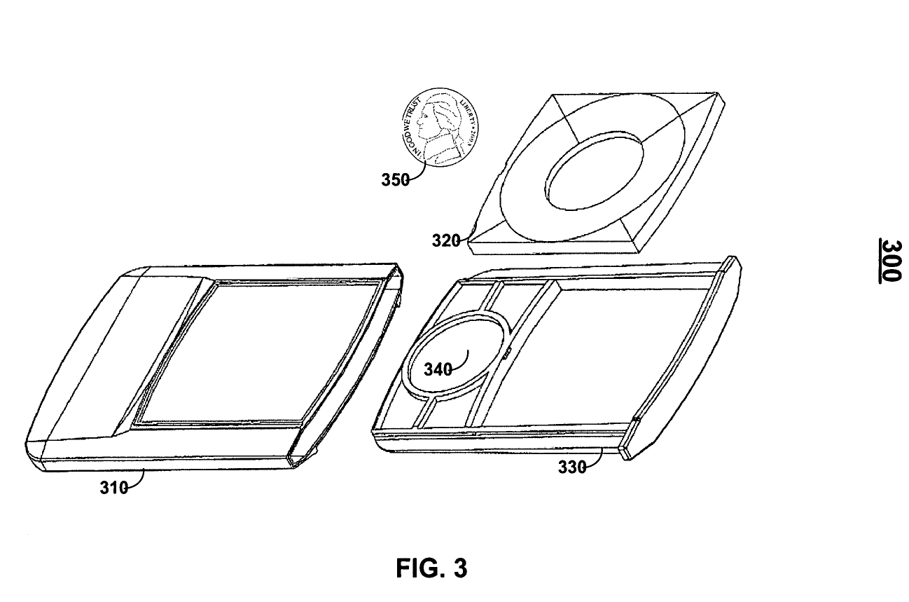

FIG. 3 shows holder components 300 that can be utilized to form a holder for collectible 350 (e.g., a coin or sportscard). Holder components 300 include sleeve portion 310, insert portion 330, component-receivable trough, aperture, or cavity 340, and collectible receivable portion 320. Insert portion 330 includes a trough, cavity, or aperture for receiving collectible receivable portion 320. Collectible receivable portion 330 may, in turn, receive a collectible. Thus, sleeve portion 310 and insert portion 330 may be reused regardless of the collectible is stored—only collectible insert portion 320 would need to be changed. Alternatively, insert portion 330 and collectible receivable portion 320 may be the same piece portion (e.g., fabricated as one structure). Alternatively still, component-receivable trough, aperture, or cavity 340 may take the form of a removable portion—such as collectible receivable portion 320.

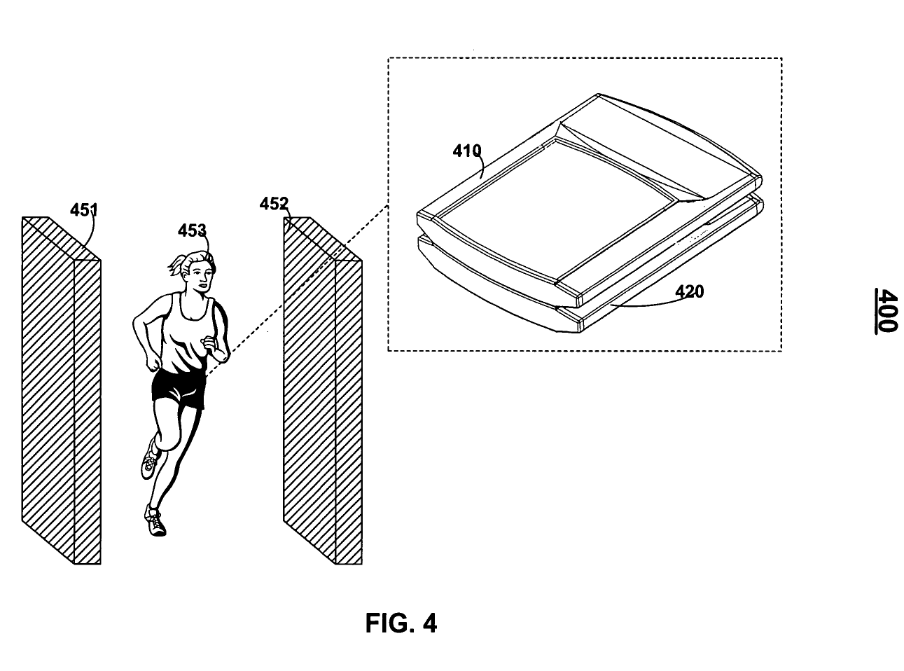

FIG. 4 shows RFID gateway 400. RFID gateway 400 may include RFID panels 451 and 452. Generally, RFID panels 451 and 452 provide power to nearby RFIDs such that such nearby RFIDs can transmit information to RFID panels 451 and 452. Similarly, RFID panels 451 and 452 receive information from RFIDs. Persons skilled in the art will appreciate that RFID gateway 400 can simultaneously power and/or receive information from (e.g., read) multiple RFIDs (e.g., 3). Thus, user 453 carrying collectible holders 410 and 420, each having an RFID, only has to walk through gateway 400 to send information.

Persons skilled in the art will also appreciate that any type of transmission/reception system may be utilized. For example, a source of energy and a wireless transmitter may be provided in a collectible holder. Accordingly, a receiver may be employed to communicate with the wireless transmitter and store any received information in a memory such as, for example, a remote database.

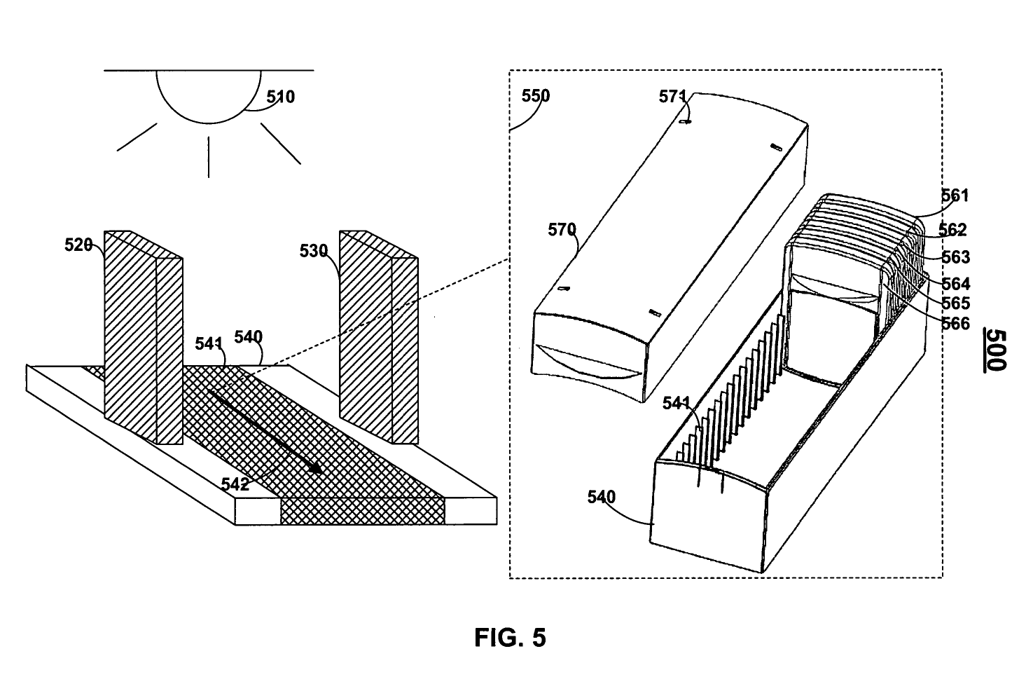

FIG. 5 shows conveyer belt gateway 500 in which RFID panels 520 and 530 are operable to power RFIDs and receive information from such RFIDs. RFID panels 520 and 530 may be provided on table 540. Conveyer belt 541 may be provided on table 540 and may in a direction past panels 520 and 510.

As a result, a user such as a dealer may place package 550 on conveyer belt 541 such that package 541 may be scanned by panels 520 and 530 or receiver 510. Receiver 510 may be any type of receiver operable to receive a signal from a transmitter embedded in a collectible holder.

Package 550 may be, for example, a holder, box, or rack that holds collectible holders in a certain position in a certain location in order to improve reading of any RFID chip, or other communicating component, in a collectible holder. For example, one RFID scanner may only be able to scan 3 holders simultaneously. Thus, a box may be provided (not shown) that holds three vertical stacks of rack 540. To stack rack 540, rack 540 may be provided with rack top 570 that includes stacking holes 571. The bottom of each rack 540 may include feet that fit into holes 571. To space collectible holders apart, multiple ridges 541 may be provided. As shown, rack 540 includes holders 561-566.

Conveyer belt 541 may be controlled in a particular manner in order to optimize RFID pannels 520 and 530 (or receiver 510). For example, conveyer belt 541 may move in a particular direction at a particular constant speed. Outlines of packages (e.g., the outline of the base of rack 540) may be painted/printed on conveyer belt 541 to exhibit to a user the optimal place to sit a rack on conveyer belt 541. Such painted/printed outlines may be spaced apart at a particular distance.

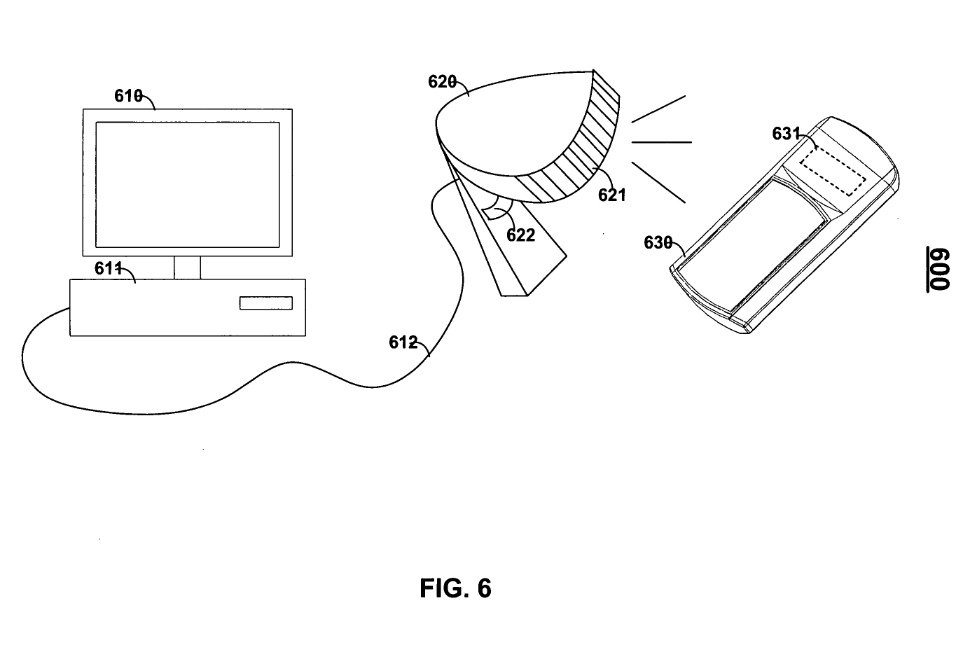

FIG. 6 shows system 600 that includes computer 611, display 610, scanner 620, communications channel 612 and collectible holder 630 having transmitting component 631. Transmitting component 631 may include any transmitting circuitry, including one or more RFID tags.

Scanner 620 may include, for example, manual control 622 and electromagnetic field generator 621. Electromagnetic field generator 622 may induce a current flow in a wire-based circuit such that the circuit may operate. Scanner 620 may also include, for example, a receiver for receiving information from a circuit, such as from an RFID tag. Thus, scanner 620 may be an RFID reader. Scanner 620 can also include an RFID encoder/writer such that information can be written to an RFID tag.

Persons skilled in the art will appreciate that scanner 620 can be any type of scanner that is utilized to receive information. As such, scanner 620 can be, for example, a barcode reader. Persons skilled in the art will appreciate that collectible holder 630 may have both labels having barcodes and RFID tags. In this manner, scanner 620 may include both an RFID reader and a barcode reader. As such, both scanners may be controlled by a single manual input. Manual inputs may take the form of, for example, triggers or buttons. Scanner 620 can communicate via wire 612 to computer 611 or scanner 620 can communicate wirelessly.

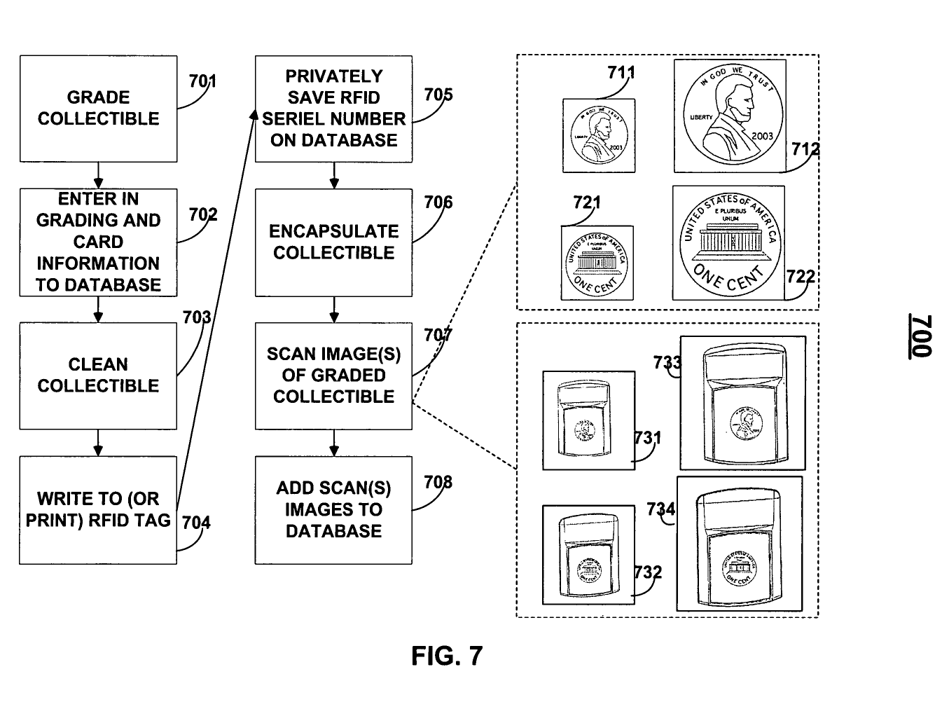

FIG. 7 includes process 700 for associating information to collectibles as those collectibles are being, for example, authenticated or graded. Step 701 may occur after a card is graded or authenticated. Step 702 may follow in which information related to the authentication (e.g., authenticator's comments) and/or grading (e.g., an ultimate grade) into a memory such as a database. The collectibles may then be cleaned at step 703.

Persons skilled in the art will appreciate that collectibles do not have to be cleaned, or that collectibles could be cleaned, when they are received by the grading, authenticating, or encapsulating company. Cleaning may be, for example, wiping the top of a coin with a cloth or blowing dust off the top of a sportscard.

In step 704, an RFID may be printed and/or encoded. Particularly, information related to the collectible may be stored on the RFID such as authentication information, grading information, population information, collectible information or any type of information.

Persons skilled in the art will appreciate that each RFID may be printed with a different identification number. This identification number may be to a database in step 705. The RFID identification number may be associated to the identification number for a collectible (or the same number can be used for both). Persons skilled in the art will appreciate that such an identification number may be stored privately on an RFID (or on a database) to prevent fraud. For example, the number may be encrypted on an RFID with a key and this key may be stored in a database associated to a collectible number. To check against counterfeiting, the collectible number can be read and used to look up the key for the encryption of the RFID number. The key can then be used to decrypt the RFID key and the decrypted RFID number can be compared against the RFID number stored in the database. Persons skilled in the art will appreciate that such a database may be a remote database that is located on a remote web-server.

The collectible and RFID (and any other components such as a label) may then be encapsulated (or placed in) a collectible holder in step 706. If the holder is sonically bonded, persons skilled in the art will appreciate that the sonic bonding can be done vertically, instead of horizontally, in order to increase the amount of light that reaches a collectible through a slab (e.g., so that the sides of a coin may be more easily seen). Sonically bonding a collectible holder that has an outer sleeve may be accomplished, for example, by only sonically bonding one side—again increasing visibility and also not requiring the additional steps of turning and aligning additional sides with an encapsulation device.

Step 707 may be provided at any point in process 700 such as, for example, after a collectible has been placed in a collectible holder (e.g., after a collectible has been encapsulated). As such, process 707 may be provided before the collectible is graded. In step 707, images are taken of the collectible. Such images may be taken from, for example, a camera, camcorder, or scanner. Multiple images may be taken. For example, images of different sides of the collectible may be taken. For sportscards, images of the obverse and reverse sides of a sportscard may be taken. For coins, images of the obverse and reverse sides of a coin may be taken in addition to images of the coins edges. Images may also be taken of different perspectives of a collectible. For example, the obverse side of a collectible may be photographed from a 90 degree angle from the table supporting the collectible and from a 45 degree angle. Alternatively, images may be taken at different distances from a collectible. Furthermore, images may be taken under different lights (e.g., ultraviolet light) or with a variety of cameras that image non-visible light (e.g., an infrared camera). Capturing images under different lights or with different types of cameras allow for the imaging of counterfeits on a collectible. Moreover, a variety of collectibles include anti-counterfeit devices when fabricated. For example, a currency may contain an image only visible under ultraviolet light. Accordingly, such an anti-counterfeit device can be imaged in stepped 707.

Multiple images may be taken of the same perspective of a collectible. Such images may be taken in different formats (e.g., GIF or JPEG), with different compression algorithms, and/or in different sizes. Thus, a thumbnail image may be taken of a perspective of a collectible that is small in size while a detailed image may be taken of that perspective of a collectible that is large in size. Persons skilled in the art will appreciate that one image of a collectible can be acquired and utilized to fabricate a number of images. For example, a high-quality image can be further compressed to be smaller in size or used to fabricate a low-quality image or an image that is a portion of the high-quality image. For example, a high-quality image of the obverse size of a sportscard can be aquired. From these images, images of the corners of the sportscard can be acquired by, for example, forming separate images—each one a crop of a corner of the original image. Such a crop can be done autonomously for every image (e.g., at a diagonal that is a percentage, such as 10%, of the diagonal of the original image) or manually.

By acquiring images of the collectible before the collectible is graded, after the collectible is graded, or after the collectible is graded, the entity acquiring the images can utilize the images in a number of ways. For example, a coin authenticating, or grading, entity can generate a collectible price guide that has pictures of a super majority, if not all, of the coins listed in the guide (e.g., the number of types of coins graded by that company). Moreover, a person that desires to purchase a company graded by an entity can go that that companies' website and view the exact coin that he/she is going to purchase. If high-quality scans are offered, the user can focus on imperfections (e.g., scratches on a coin) at a level not offered by, for example, pictures posted to online auctions. Moreover, the grading, or authentication service, can offer a virtual collection for a user. The virtual collection can include all of the coins that user has graded with the entity. As such, website may offer an online auction option in which a listing is autonomously generated for the user. The pictures for such a listing can be obtained from the images that were acquired by the entity when the entity graded the collectible. Alternatively, a user with a collectible that is not computer savvy can obtain the image of a collectible from the grading, or authenticating, entities, website instead of acquiring the image himself by scanning the collectible or taking a picture of the collectible. Such images can be used, for example, for an online auction listing (e.g., an eBay listing).

As shown above, images taken in step 707 may take many forms. For example, images from step 707 may include pre-encapsulated obverse thumbnail image 711, pre-encapsulated obverse high-quality image 712, pre-encapsulated reverse thumbnail image 721, or pre-encapsulated reverse high-quality image 722. Alternatively, images from step 707 may include encapsulated thumbnail obverse image 731, encapsulated high-quality obverse image 733, encapsulated thumbnail reverse image 732, and encapsulated high-quality reverse image 734.

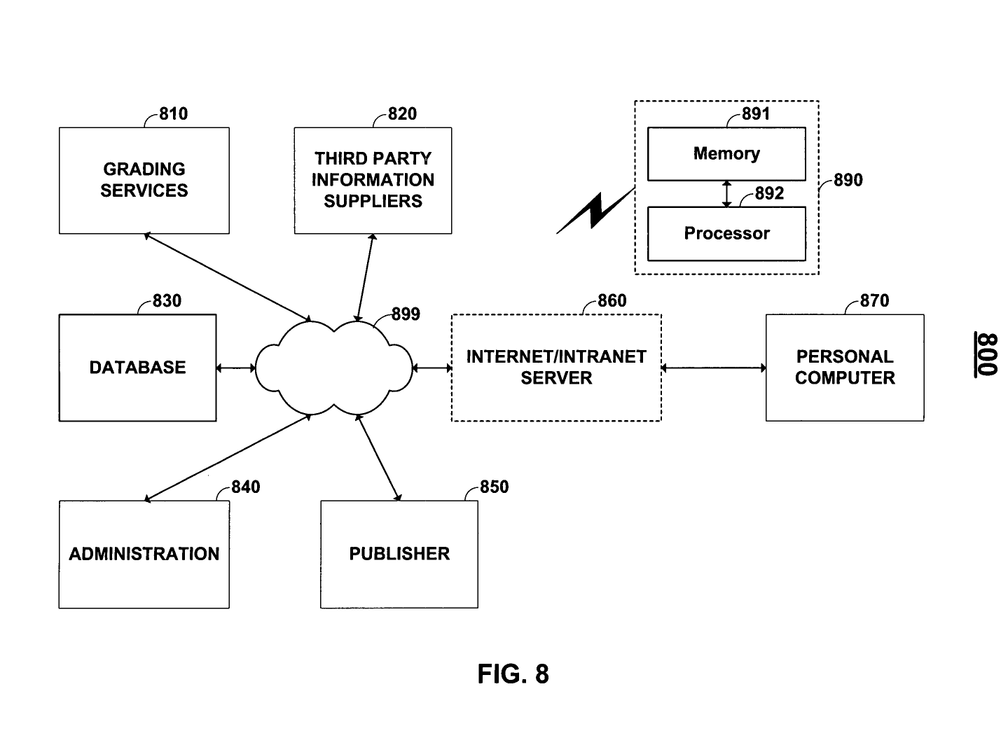

FIG. 8 shows network topology 800 that includes, for example, grading services 810, third party information suppliers 820, database 830, administration 840, publisher 850, internet/intranet server 860, personal computer 870, and wireless device 890. Wireless device 890 may include, for example, memory 891 and processor 899. The components/entities of topology 800 may communicate through network 899. Network 899, in turn, may be any type of communication channel such as a wireless or wire-based communications channel.

Persons skilled in the art will appreciate that the components/entities of topology 800 may share information. For example, grading services 810 may obtain pricing information from online auctions (e.g., third party information suppliers 820), autonomously generate a price guide using this information with pictures obtained of collectibles from grading services 810, and provide such pictures and price information to publisher 850 for publishing. Administration 840 may be utilized to modify any information in topology 800. For example, administration 840 may be utilized to update the website of grading services 810.

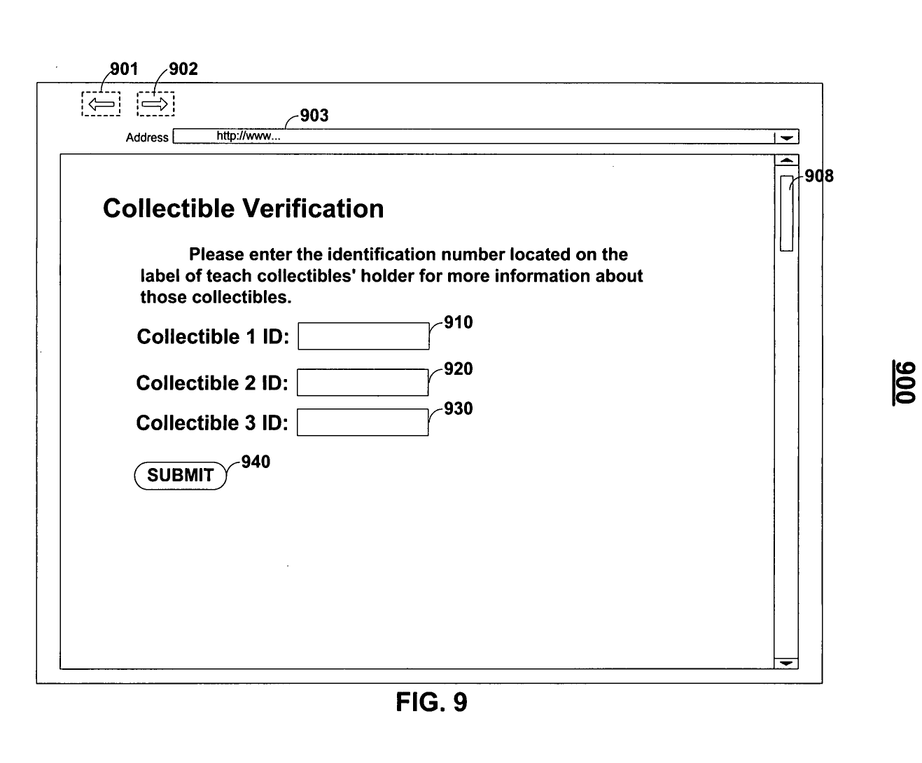

FIG. 9 shows GUI 900 that may include GUI controls 401-403 and 409. GUI 900 may be the GUI of a non-internet enabled program, an internet-enabled program, or an internet browser. A non-internet enabled program does not obtain information from third parties (e.g., auction houses or grading companies) from the internet while an internet-enabled program does.

Generally, GUI 900 may be a page on a grading/authenticating companies website used to verify a collectible. For example, a potential buyer may be provided the specific collectible identification number of the collectible the potential buyer desires to acquire for a particular grading/authenticating company. Upon entering this identification number into GUI 900, a user may be provided with information about that collectible. A user may enter information by typing the information into text boxes 910, 920, and 930 and pressing SUBMIT button 940. Such information may be utilized to look up information corresponding to that collectible in a memory such as a database. The user may be provided with this information on a GUI. Such information may include, for example, grading information, grader's comments, collectible information, pricing information and owner information. Additionally, pictures taken of the collectible can be displayed to a user such that the user can examine the collectible up close. Navigational tools 901, 902, and 903 may be provided (e.g., to navigate around an internet). Viewing tools 908 may be utilized to scroll through a document/webpage.

Taking pictures at different times in the grading/authentication process can also protect against in-house theft as well provide showings of in-house damage. For example, a guarantee can be provided to a grading companies client that a collectible (e.g., sportscard) sent in for grading will not be damaged while in the hands of the grading entity. By taking a picture of the collectible after it has been unpacked (but before it has been removed in any collectible holder used to ship the collectible inside of a shipping package) and a picture of the collectible after it has been encapsulated, the client can check to see if the guarantee can be claimed against a particular collectible. Moreover, a grader could “switch” collectibles during grading. For example, a grader could replace a 1950 Bread for Energy George Mikan in MINT condition with a 1950 Bread for Energy George Mikan in FAIR condition (a lesser condition). Photographing the collectible at multiple stages can protect from such in-house theft.

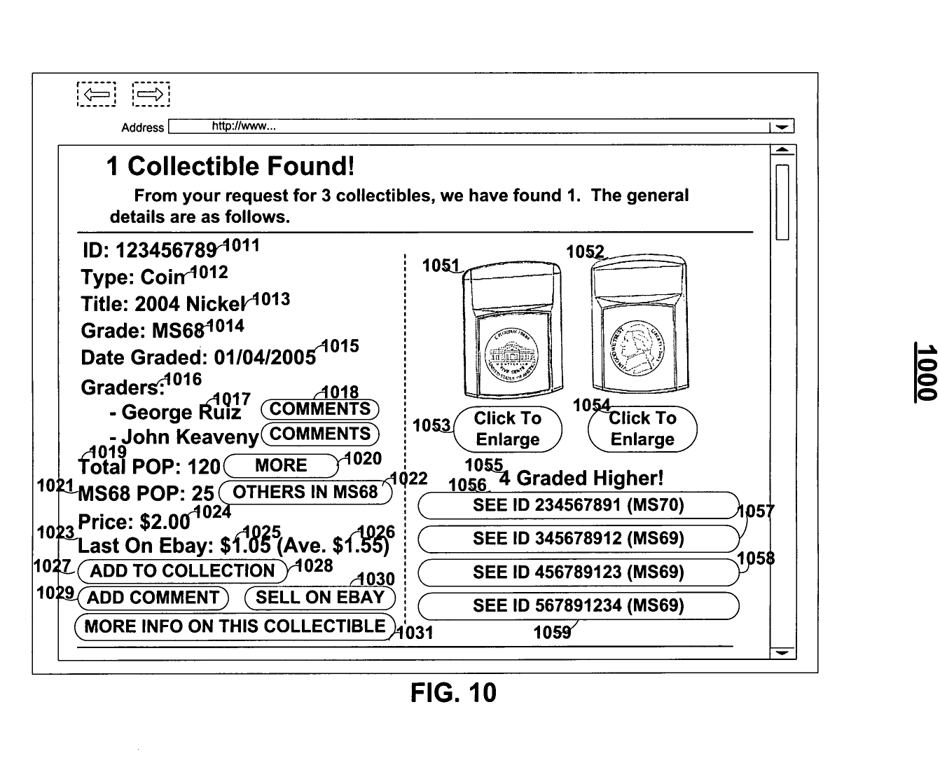

FIG. 10 shows GUI 1000 that includes information that may be displayed for a collectible that is requested. A collectible may be requested, for example, by clicking on a collectible on an online store or entering in a collectible's specific identification number in a GUI such as GUI 900 of FIG. 9. GUI 100 may include the number of collectibles returned from a search, collectible identification number 1011, collectible type 1012, collectible name 1013, collectible grade 1014, date graded 1015, grader information 1017, grader comments 1018, total population information 1019, additional population information 1020 (e.g., populations for related collectibles), price 1024 (e.g., price estimated by a grading company), last online auction price 1025, average online auction price for a period of time 1026, add to collection button 1027, sell on eBay button 1030, more information button 1031, reverse picture 1051, obverse picture 1052, enlargement buttons 1053 and 1054, and similar collectible information (e.g., collectible information 1056-1059).

Add to collection button 1027 may ask for verification of ownership. Verification of ownership may be utilized, for example, to allow access to an automated online auction generation tool. Verification can be obtained by, for example, comparing the owner of the collectible at time of grading information to the owner information of a user profile associated with the user logged into GUI 1000. Persons skilled in the art will appreciate that when a collectible is sold, the buyer can request transfer of the collectible such that GUI 900 recognizes the collectible as belonging to the buyer. Such a virtual transaction of the collectible from one virtual collection to another can be done by, for example, sending a transaction code to the seller. The seller can then transmit the transaction code to the buyer and the buyer can, in turn, enter the transaction code into GUI 900 such that the collectible is virtually transferred. Persons skilled in the art will also appreciate that a person that submits a collectible for grading/authentication can instruct the grading/authentication company to immediately sell the collectible at auction (e.g., on eBay) or physically hold the collectible until the user decides to sell the collectible. As such, a collectible in a virtual collection could be utilized by a grading/authenticating entity as proof of ownership of the physical collectible. Thus, collectibles can virtually be sold/transferred without requiring the physical transfer of the collectible (e.g., only the transaction code needs to be transmitted). Such trading/transacting can allow for cheaper collecting as shipping costs would not have to be paid. When a collector desires to obtain the physical copy of the collectible, the user could, for example, hit a “Send Collectible Now” button and the grading/authenticating entity could immediately send the collectible to the user. Data about the transaction history between collectors can be recorded on an RFID, or in a database associated to a specific collectible identification number, so that the ownership history can be obtained and confirmed for future authentication purposes.

Additional population information 1020 may be, for example, a chart of the population information for every collectible in a set (e.g., every player card in a 1957 Topps Basketball set) as well as a rarity ranking for each card and/or each possible grade for a card (e.g., a ranking of the cards with the least number of cards graded or the least number of cards of a particular grade graded).

Similar collectible information may include, for example, any information for collectibles similar in price, type, name, owner, seller, grade, graders, or any other similar information. An option may be provided to the user (e.g., a menu) for determining the type of similar collectibles that are provided to a user. Thus, a user can toggle between similar owner collectibles and similar type and grade collectibles. Thus, a user can see how many of a type of collectible (e.g., 2004 Nickel) has been graded MS68 (or higher) and then click on buttons 1056-1059 to obtain information about that collectible (e.g., information presented in a GUI similar to GUI 1000 of FIG. 10).

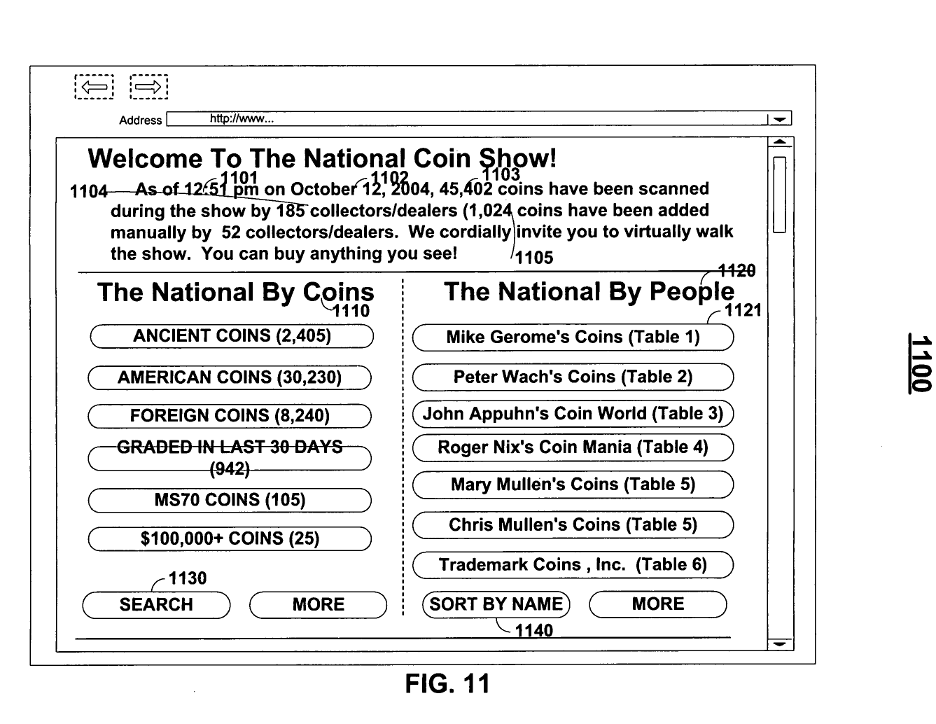

FIG. 11 shows GUI 1100 that may be utilized, for example, as a virtual convention or a virtual store. As discussed above, a convention may have a scanner, or group of scanners, for scanning RFID-enabled holders. Such scanners can take the form of hand-held scanners, conveyer belts, or gateways. A dealer can present himself/herself to the entity providing GUI 1100 and have his/her collectibles scanned. All collectibles scanned during this time can be associated to the dealer and a program can be utilized to autonomously generate, for example, an online store for that dealer and/or a listing of collectibles for that dealer for a convention. Similarly, a collector looking to sell collectibles can have the collectibles scanned in and, for example, online auctions can autonomously be generated, an online store can be generated, a virtual collection can be generated, or the collectibles can be listed on a virtual convention as being sold by a non-dealer (e.g., a visitor to the show). Thus, GUI 900 affords a person that was not able to make the show, the ability to view, buy, and even sell collectibles with dealers/visitors at the convention.

To generate GUI 1100, information may be obtained form a variety of sources such as, for example, from a database storing collectible information for a grading and/or authenticating company. Thus, a scanner can read in a number of specific collectible identification numbers, retrieve information from a remote, or local, database for those identification numbers, and generate a webpage for that identification number. Persons skilled in the art will appreciate that if an online store or online auction is generated that the user may be provided with the opportunity to enter in pricing and shipping data such that any generated store or auction includes this information.

A dealer that provides collectible information can also provide information as to the dealers location and contact information for a convention/show. Thus, physical visitors can locate the dealer (and as such a map may be provided on GUI 1100), while online visitors can contact the dealer.

Collectibles may be, for example, organized by the type of collectible (e.g., organization 1110) or by the people selling collectibles (e.g. organization 1120). Buttons/links may be provided to take a user down a level in an organizational scheme. For example, pressing button/link 1121 may allow a user to see a list of the collectibles that are on sale for a user associated to button/link 1121. Numerous types of information may be dynamic and may be obtained from, for example, a database to be displayed on a GUI. Such dynamic information may include, dynamic time information 1101, date information 1102, total number of coins at a location/event information 1103, number of collectors/dealers at a location/event information 1104, as well as information 1105 regarding what and what number of collectibles were entered manually and what and what number of collectibles were entered autonomously (e.g., via reading an RFID tag). Search engine 1230 may be provided to help a user locate a collectible by allowing a user to enter information about a collectible and searching a database for information similar to the entered in information. Sort engine 1140 may be provided to sort collectibles on a GUI by name, grade, price, owner, or any other piece of information stored for a collectible.

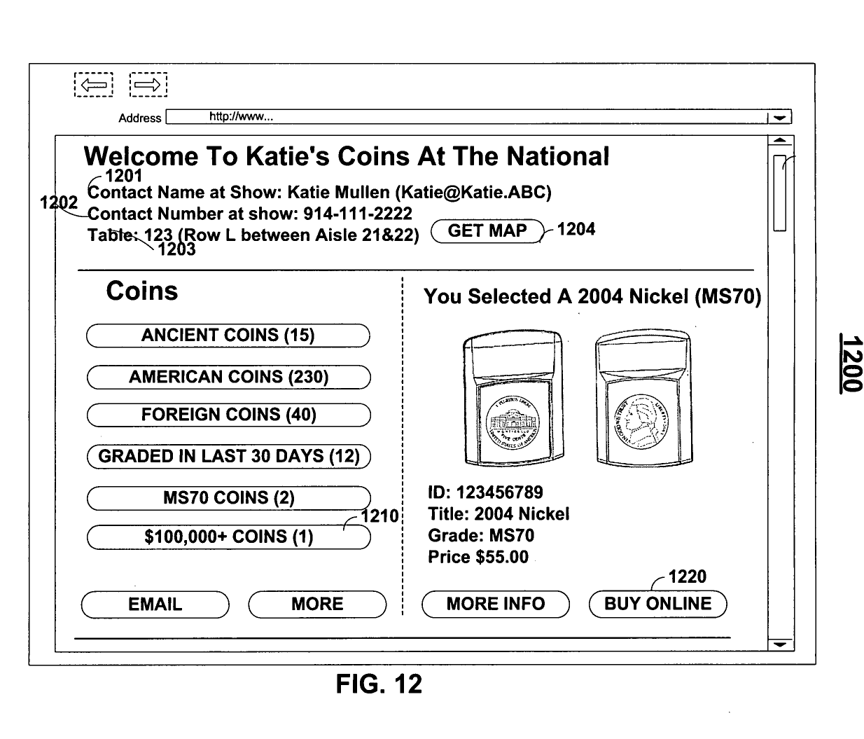

FIG. 12 shows GUI 1200 that includes, for example, a dealer/collector's listing of collectibles at a convention/show. For those collectibles not in RFID-enabled holders, the dealer/collector can enter in collectibles, and associated information, manually. Such entries, however, may not allow for the entry of information such as authenticated grading information. A collectible listing for a dealer/collector can include any type of information such as specific collectible identification information, name information, grade information, pictures, and price information.

Collectibles can be organized in categories. A dealer/collector, viewer, or administrator can define such categories. One such category may be the most recent collectibles have been graded and/or authenticated. As such, collectibles can be categorized according to the collectibles that have been graded during a period of time, such as a most recent period of time (e.g., 30 days).

A personal webpage may be, for example, a GUI similar to GUI 1200 and the personal webpage may be accessed either via an internet address or by traveling through a button/link on another page (e.g., button/link 1121 of FIG. 11). Such a personal webpage may be associated to a user and may include dynamic information retrieved from a database such as contact information 201, contact number (e.g., a show specific contact number) 1202, and location (e.g., a show specific location). Button/link 1204 may also be provided to display a map to the user with an indicator (e.g., a picture of an object such as an arrow or star) of where the user associated to the personal webpage is located. Collectibles can be organized in any manner. A user of the personal webpage can define how the collectibles are organized and can create folders/destinations to place particular collectibles in. For example, a user can create “$100,000+Coins” folder and, as a result, button/link 1210 may be displayed. The user can then place a collectible into this folder and the number of items in a folder can be displayed to a user (e.g., “(1)”). Alternatively, folders can be autonomously created based on information associated with a collectible or a group of collectibles (e.g., the coins can autonomously be sorted, and displayed, according to the grade each collectible received). A user may be provided with general schemes to choose from for automatically organizing collectibles (e.g., by grade, price, year). BUY button/link 1220 may be provided such that a user may purchase any particular collectible.

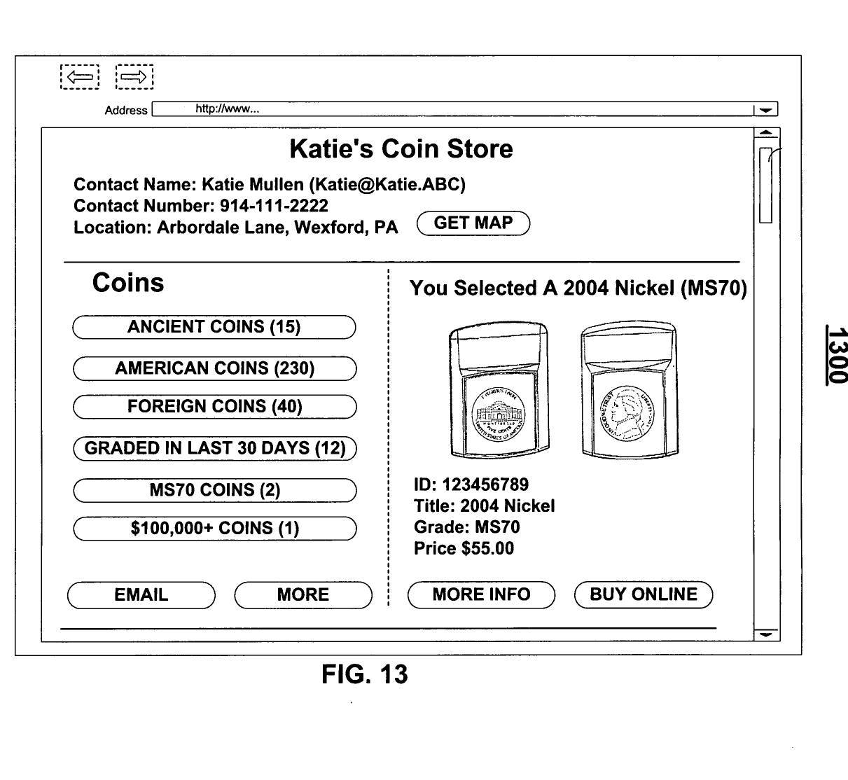

FIG. 13 shows GUI 1300 that may be, for example, an online store for an entities collectibles. GUI 1300 may include different information than, for example, the information in GUI 1200 of FIG. 12. For example, a dealer may only bring a small number of collectibles from his/her business to a convention/show. Alternatively, different contact and/or location information may be provided depending on if a GUI is for an online store or convention listing.

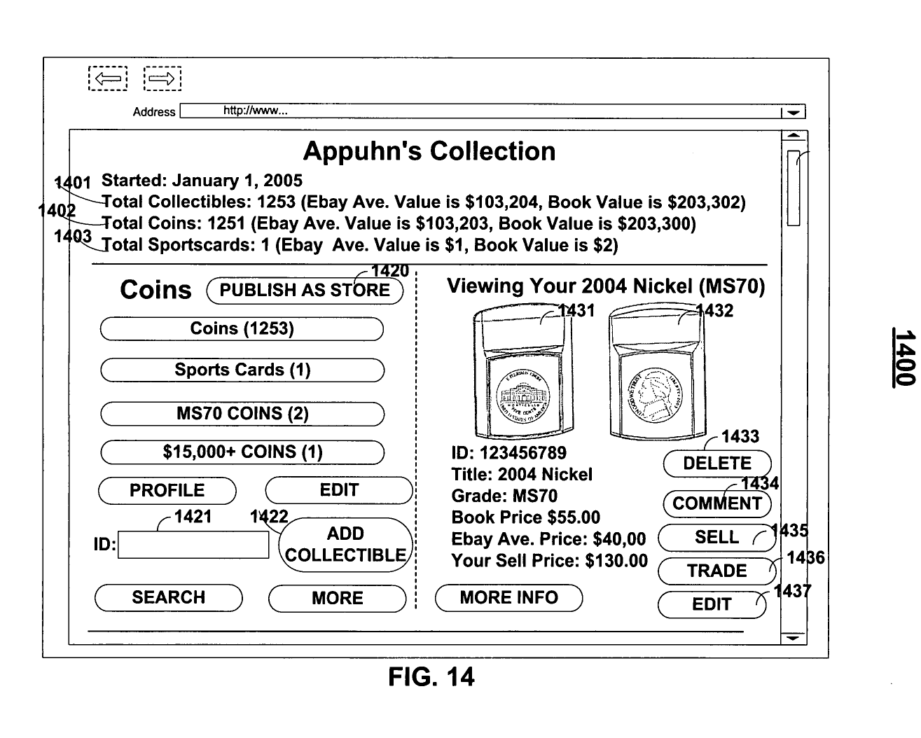

FIG. 14 shows GUI 1400 that shows a virtual collection for an entity. Such a virtual collection can include, for example, the date the collection was started (and duration collection has been in existence), the total number of collectibles in the collection, the value of the collection according to a particular source (e.g., price guide) or online auction (e.g., ebay), the value of a collection of a general type of collectible (e.g., the value of the coins in the collection or sportscards in the collections), the option to publish the collection and/or collectible as a store, auction the collection and/or collectible, add collectibles, comment on collectibles, delete collectibles, trade collectibles, and edit information for collectibles.

GUI 1400 may include an administrators interface that allows a user to enter in and edit information about a collectible. For example, GUI 1400 may allow a user to set a price to sell a collectible as well as determine how to sell that collectible (e.g., via eBay or through a collector's community such as a community managed by a grading service). Button 1420 may be included to publish coins that are entered into an administrative system onto a website. Thus, a user can use button 1420 to toggle between keeping a particular collectible private or public. To add a collectible, a user may enter a collectibles specific identification number into text box 1421 and then press button 1422 to add that collectible. Once button 1422 is pressed, information may be retrieved from a database (e.g., a database entry associated with the specific identification number that was entered) and this retrieved information may be utilized to provide additional information about the specific collectible (e.g., the grade the collectible received or the name of the current owner associated with the collectible). A user may then add a comment to information using button 1434 (e.g., and say that the old owner information is wrong and provide the new owner information) or edit particular information. Some information may be editable (e.g., user comments). Some information may only be read and may not be edited (e.g., the grade of a coin). If information is edited, this information may be updated on a server (e.g., a server remote from the device providing GUI 1400). Such a GUI may allow a user to enter in his/her entire collection. Information about the collection may be displayed as information 1401 (e.g., total collectibles along with average auction value for the collection and book value for the collection). Such information may also be displayed for particular groups of collectibles such as coins (e.g., information 1402) and sportscards (e.g., information 1420). A user may delete a collectible, or any type of item, using delete button 1433 and may sell any item by utilizing SELL button 1435. Persons skilled in the art will appreciate that SELL button 1435 may be utilized in a variety of ways. For example, SELL button 1435 may be displayed after an offer is received for a collectible such that if a user presses SELL button 135, the collectible immediately sells. Alternatively, SELL button 1435 may be utilized to initiate an offer to sell the item either through, for example, an online store or an online auction. Similarly, TRADE button 146 may be provided to make an offer to trade a collectible or offer to trade the item through an online trading exchange.

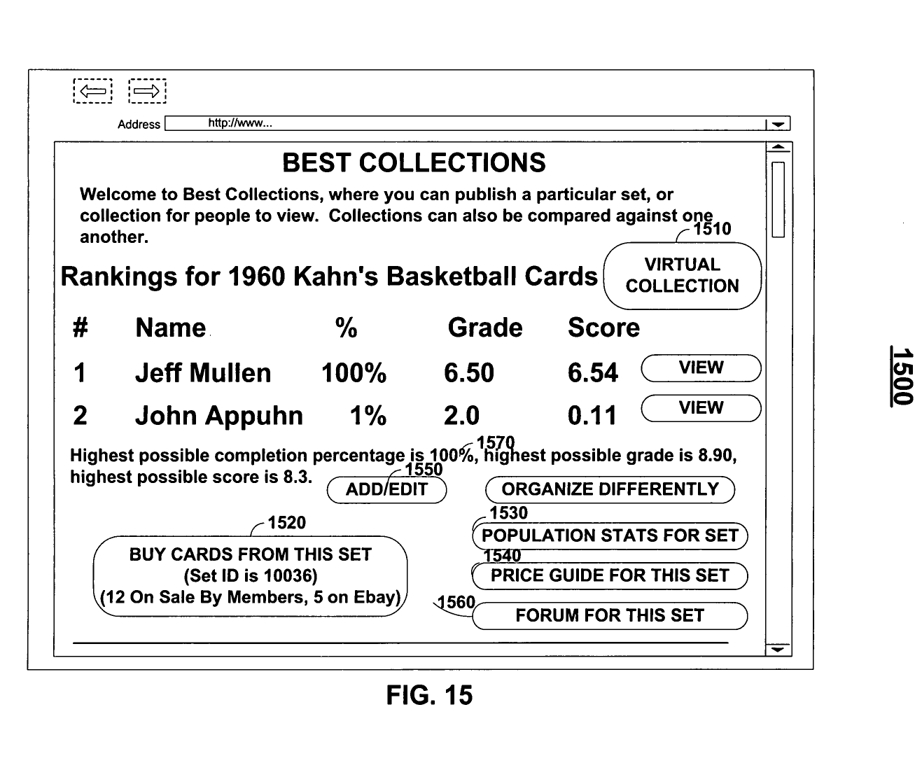

FIG. 15 shows GUI 1500 that includes a listing of the best collections for a particular set, collectible, collection, or person. The best collections listing can be ranked by completion percentage, average grade, or a score. A score may be allocated depending on, for example, the rarity of a coin multiplied by the grade of a coin. The rarity of a coin may be associated to a coin's grade and population. Persons skilled in the art will appreciate that if a particular set or specific collectible is selected that the GUI can display information as to how many are on sale at a particular auction house or online store. Sets can also be given identification numbers to help, for example, facilitate in finding similar collectibles on an online auction site or an online store.

Each collection, set, and/or collectible can be provided with an online forum, price guide, chat room, and/or population stats that can be accessed on, for example, a GUI associated to that set and/or collectible. In addition to virtual collections being provided to collectors/dealers a virtual collection can be provided for reference purposes. Such a virtual collection can include pictures from previously scanned coins. Such a virtual collection can be randomly chosen each time a user selects the virtual collection. For example, if the user is viewing the rankings for a 195 Topps Basketball set, the pictures of each card of the set can be randomly chosen from those acquired and utilized to provide a virtual collection of that set such that a user can view all of the cards in the set. Price information, ownership information, and population information, for example, can be provided for a specific collectible or a type of collectible.

GUI 1500 may provide a list of the best collections for any particular set of collectibles. Virtual Collection button 1510 may be provided, for example, to show pictures of one or more perspectives from every collectible in the set. Such a virtual collection may be populated with images associated to collectibles from a plurality of different owners such that a complete virtual collection for a set may be provided before any individual user finishes a set. Virtual collection button 1510 may also be utilized by a user to view pictures of every collectible in his/her collection or to view pictures of every collectible in another user's collection. Button 1520 may be provided to display to a user a list of collectibles from the set associated to, for example, a particular set that are available for sale or trade. Button 1530 may be utilized to provide population statistics for each collectible in a set (which may include a population for each different grade). Button 1540 may prompt GUI 1500 to display a price guide for a particular set of collectibles (e.g., the set of collectibles associated with GUI 1500). Button 1560 may be provided to allow a user to navigate to a forum associated with the set associated with GUI 1500 so that the forum may be displayed to a user. Any number of GUIs 1500 may be provided depending on the number of different sets that are being collected. Additional information, such as information 1570 indicative of the highest possible completion percentage given the collectibles that have been graded to date may be displayed.

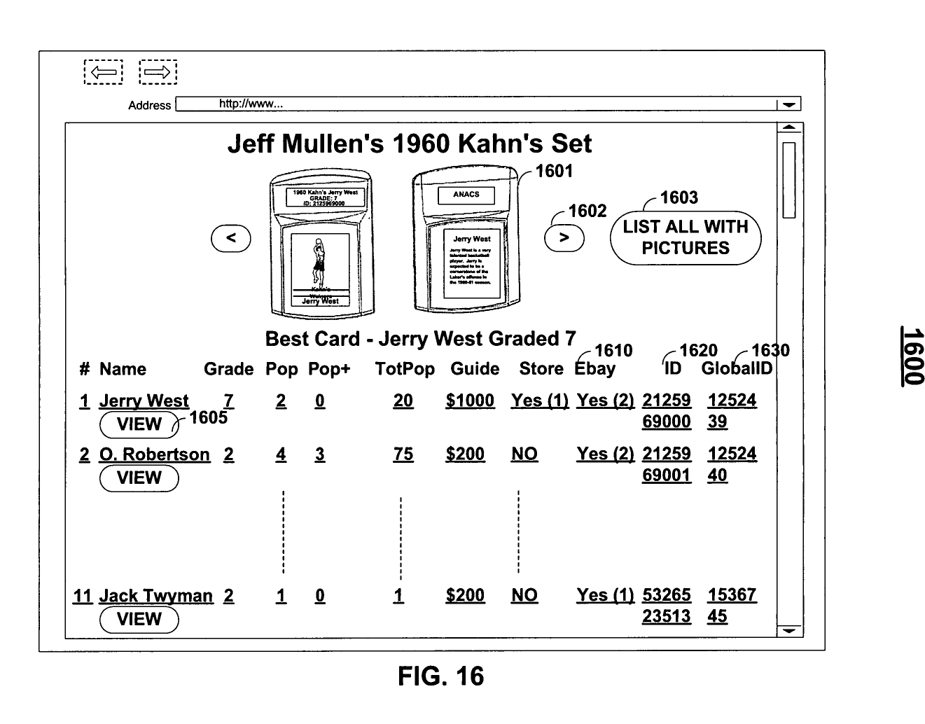

FIG. 16 shows GUI 1600 that includes a set entered for a particular entity (e.g., the collector/dealer Jeff Mullen). A window may be provided to scroll through the pictures of cards in such a set (e.g., one-by-one or group-by-group). Information about the set and each card in the set may also be displayed.

GUI 1600 may include the best cards that a user has for a particular set. Thus, if a user has multiple Jerry West cards, GUI 1600 may autonomously determine what Jerry West card is the best (e.g., has the highest grade) and display this card. Alternatively, a user may manually determine what Jerry West card is to be associated with what set (as a user may have multiple copies of any specific set). A user may be provided with pictures 1601 of different perspectives of a card from the set and the user may use navigational tools 1602 to navigate through collectibles on-by-one. Button 1607 may be provided to allow a user to view pictures of all the cards in the set at once. A large amount of information about each collectible may also be provided as well as additional buttons (e.g., button 1605 to view pictures of a specific card). For example, information about how many similar cards are for sale in online marketplaces or auctions (e.g., information 1610) may be provided. Any collectible may have more than one identification number. For example, a collectible may have an identification number provided by a grading/authentication service (e.g., information 1620) as well as an online auction identification number as well as a global identification number (e.g., information 1630).

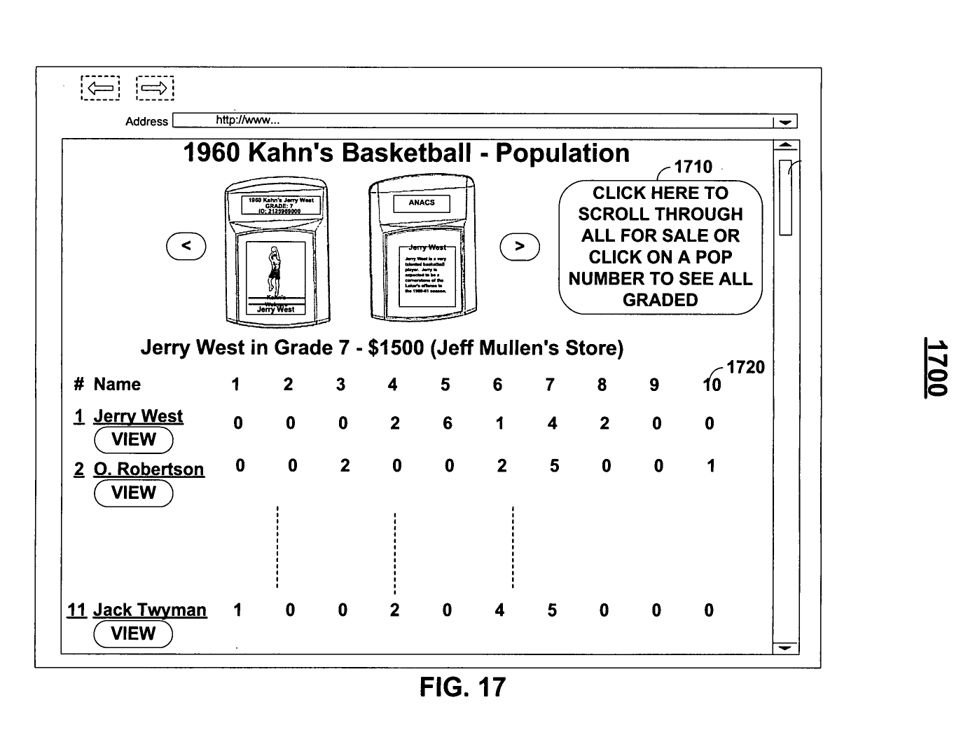

FIG. 17 shows GUI 1700 that may include a listing of the population for a particular type, or set, of collectibles. For general information, such as general population information, a window may be provided (e.g., an embedded frame) that automatically scrolls between, or allows for manual scroll of, collectibles on-sale that fit the set, or type, of collectible displayed in GUI 1700.

GUI 1700 may display information regarding the population of one or more particular cards (e.g., by grade). Population screens may be organized based on sets of collectibles of the same type (e.g., 1961 Fleer Basketball Cards). Button 1710 may be included to display to a user items associated with a particular population report (e.g., the population of collectibles in a particular set of collectibles) that are on sale. The population of every collectible may be, for example, divided into grades such that the number of a particular collectible graded a particular grade is shown. For example, a column may be provided associated to grade “10” and the number of collectibles that have received this grade for any particular collectible may be entered in the appropriate position in such a column. The population number may be used as, for example, a link such that a user may click the population number and may be displayed additional information about the collectibles represented by the number (e.g., who the owners of each collectible are as well as how to contact each owner). The service providing GUI 1700 may charge a fee (e.g., $1) to provide contact information about a particular owner or may take a percentage of the sale (e.g., 5%-10%). Information, for example, about collectibles retrieved from a population report link may also include information regarding whether or not collectibles for that population are for sale.

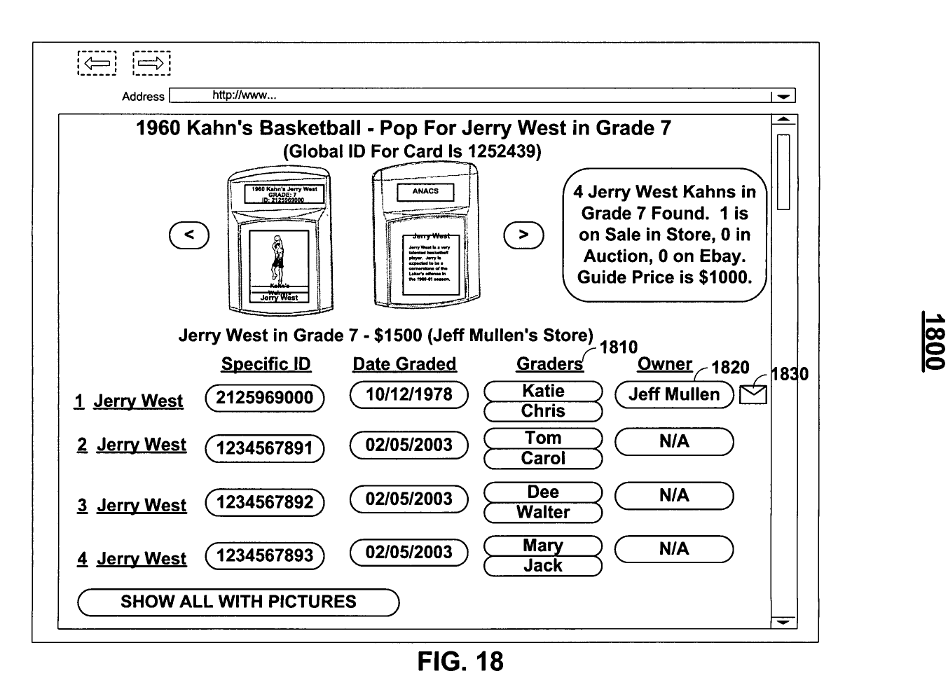

FIG. 18 shows GUI 1800 that may include population information for a collectible (e.g., a 1960 Kahn's Basketball Jerry West). Such a list can be a list of all collectibles graded (in an order dependent upon, for example, price, quality, date graded, graders, and/or owner). Any collectibles displayed on GUI 1800 that are available for sale or trade may be displayed in, for example, one or more frames. Users can scroll through pictures of the collectibles in such frames and click on the picture to bring up a screen having information about the selected collectible (or the online store page for the selected collectible).

GUI 1800 may be provided to display, for example, the population report of a particular card such as the population of a particular card in a particular grade. GUI 1800 may be accessed, for example, by clicking on a link on another population report (e.g., clicking the number, such as “4”, of Jerry West 1960 Kahn's that graded in at “7”). GUI 1800 may include detailed information about each specific collectible associated with GUI 1800. For example, grader information 1810 may be provided and a user may click on a particular grader to see additional information about the grader (e.g., what other collectibles the grader has graded and the type of grades the grader has given for particular types of collectibles). More than one grader (e.g., two or three) may be utilized to grade a particular collectible. Owner information 1820 may also be provided and owner information 1820 may be utilized as a gateway (e.g., through button/link) to a GUI that displays the owners collection (or online store). Contact information 1830 (e.g., an email address) may also be provided.

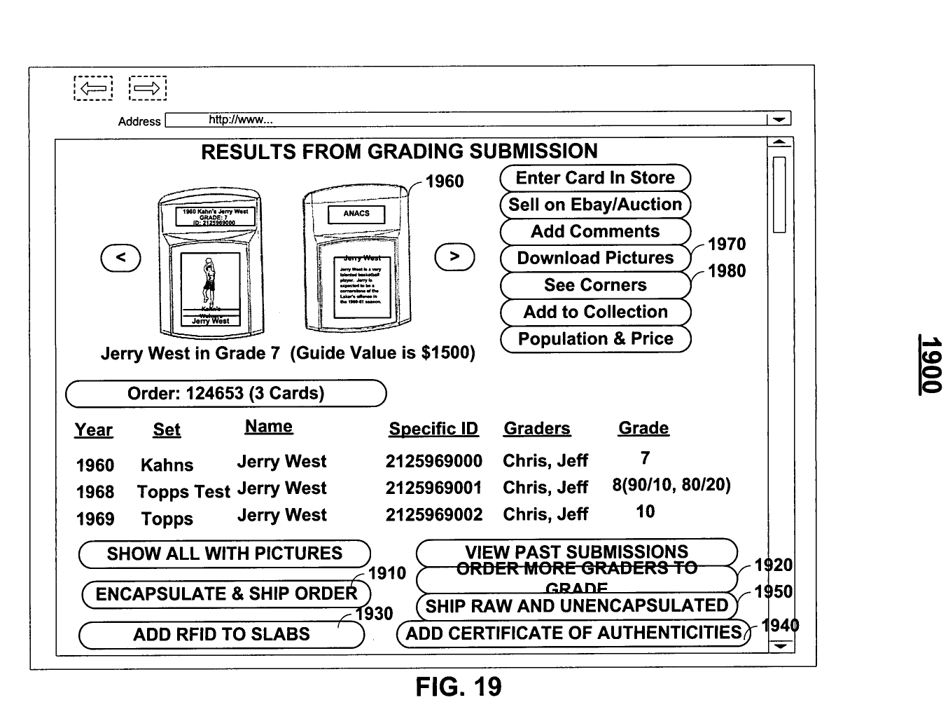

FIG. 19 shows GUI 1900 that allows an entity to view the results of a group of collectibles submitted by that entity to a grading and/or authentication service. A link to GUI 1900 may be provided, for example, in an email to the submitting entity as soon as the grades and/or authentication results are obtained, as soon as a collectible is registered as being received, as soon as a collectible's image is acquired, or as soon as a collectible is encapsulated. GUI 1900 can include buttons to enter the collectible into an online store, sell the collectible on eBay, add comments, download pictures, see perspectives or areas of a collectible (e.g., different corners), add to a virtual collection, obtain population information, obtain pricing information, see order information, view past submissions, order more graders to grade, ship raw and/or unencapsulate, add certificate of authenticity, add RFID to slabs, encapsulate and ship order, and show all graded with pictures.

GUI 1900 provides a variety of useful functionality. For example, GUI 1900 can be provided after a collectible is graded/authenticated but before the collectible is authenticated. A user can then determine whether to encapsulate the collectible (e.g., at an additional cost), add components to the encapsulation (e.g., an RFID at an additional cost), ship back without encapsulating, and/or add a paper certificate of authenticity for a collectible. A user can utilize button 1910 to encapsulate and ship an order. A user can utilize button 1920 to purchase additional graders to review a particular grade. A user can utilize button 1930 to add an RFID to a slab (e.g., at an additional cost). A user can utilize button 1940 to add a certificate of authenticity to an order (e.g., which may reside outside of a slabbed collectible). A user can utilize button 1950 to ship the collectibles raw and unencapsulated. A user can view the collectibles (in either raw or encapsulated form) from a grading submission and such collectibles may be displayed with pictures 1960. Such pictures (e.g., taken by the grading service before/after grading) may be downloaded by a user using download picture button 1970. Closeup pictures may also be displayed/downloaded of particular features (e.g., corners for sportscards, edges and portions of faces for coins) using button 1980. Persons skilled in the art will appreciate that all collectibles may be encapsulated and if a user decides to ship the cards unencapsulated, the collectibles may be broken out of the encapsulation (e.g., by physically breaking the slab). A fee may be charged for this such that all collectibles are encapsulated, but a breaking process costs and additional fee (e.g., approximately $1-$5).

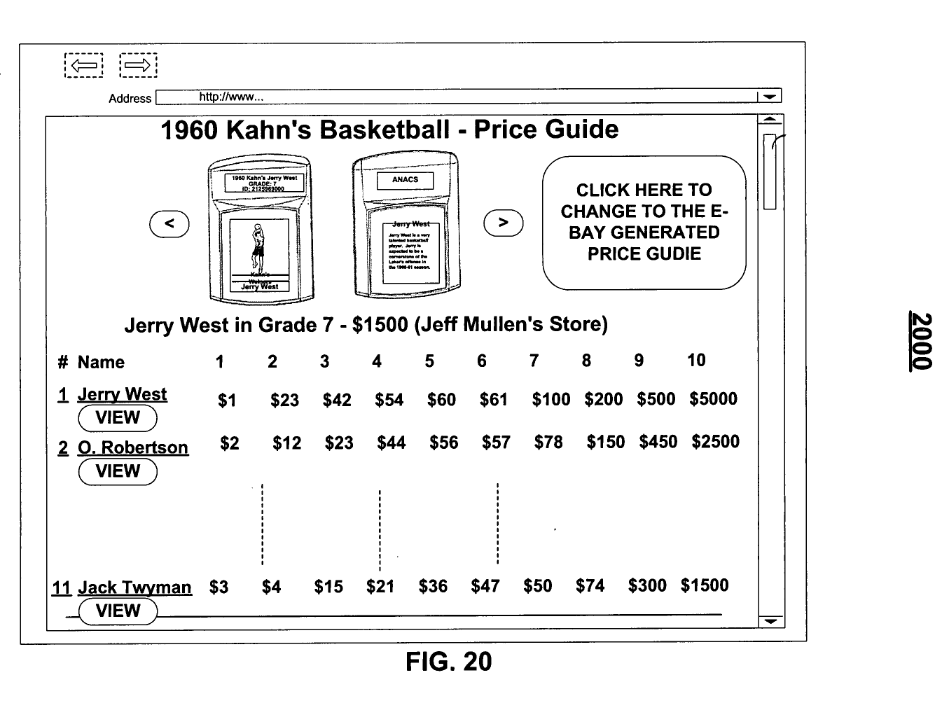

FIG. 20 provides GUI 2000 that shows a price guide for a collectible or set of collectibles. GUI 2000 can display, for example, either an online auction price guide or a price guide determined by, for example, the grading/authenticating entity. A user may be provided with controls for toggling between the two (or more) guides or manipulate how data is displayed. Persons skilled in the art will appreciate that an online auction price guide may be dynamic in that it continually updates (e.g., either according to an average price for a period of time or the last price paid or both) or static in that it retrieves a stored price that only changes when manually changed (e.g., when the grading authority or a third party authority issues a new price guide).

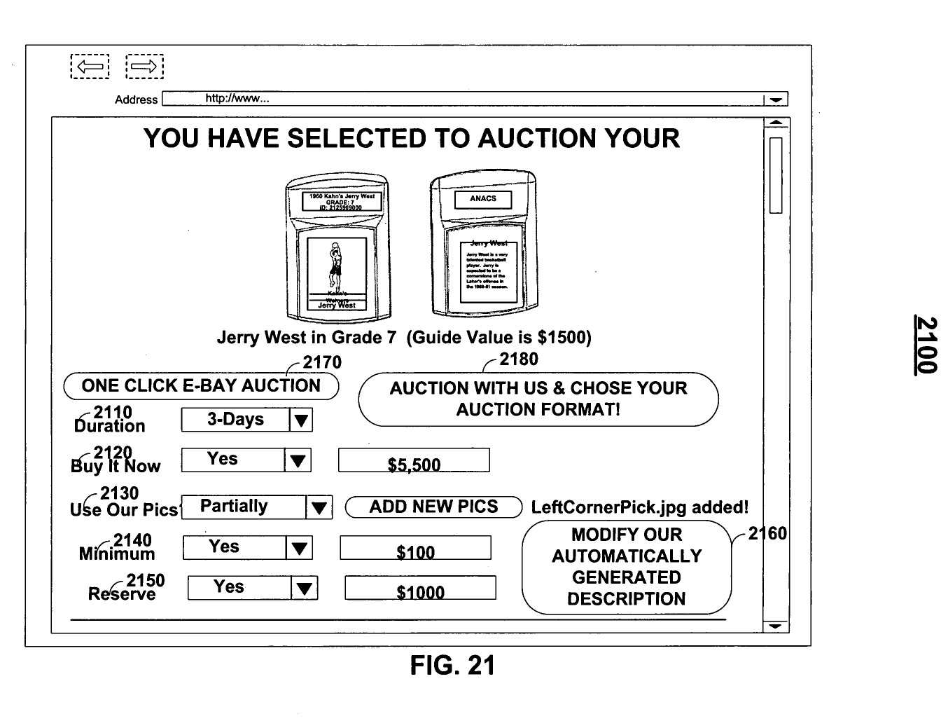

FIG. 21 shows GUI 2100 for auctioning (or selling) a collectible). After a collectible is scanned, entered by entering a specific identification, or entered in another way, the collectible can be auctioned or sold. Online stores or online auctions can autonomously be generated and allow particular types of information to be manually added by a user. Such information may be, for example, the duration, type of auction (e.g., a particular auctioning entity), but it now options, picture options, minimum price, reserve price, shipping information, or add description. A description can autonomously be generated by, for example, retrieving information about a collectible (e.g., name information, grade information, and history of the collectible). Population information and historic pricing information can also be provided in, for example, and autonomously generated auction or store listing.

Duration selector 2110 may be provided to determine the duration of the auction. Buy it now selector 2120 may be provided to allow a user to enter in information regarding when a user can but the product and skip the auction. Picture selector 2120 may be provided and may be utilized to obtain pictures already associated to the collectible or may obtain the pictures from a third party (e.g., the grading service). Selector 2140 may be utilized by a user to provide minimum pricing information. Selector 2150 may be utilized by a user to provide reserve pricing information. A description for a collectible may be automatically generated (e.g., from a collectible guide) and button 2160 may be utilized to modify/add to this automatically generated text. Buttons 2170 and 2180 may be utilized to initiate an auction with different entities (e.g., button 2170 may be utilized for eBay and button 2180 may be utilized to initiate an online auction run by the grading service). Such a grading service auction may allow a user to select multiple forms of auction formats such as highest price sealed bid auction format, second-highest price sealed bid format (e.g., where the winner is the user that bid the highest amount, but the sale price is the second highest amount), a reverse auction, an open bid auction lasting a duration of time (e.g., approximately a week), or any other type of auction.

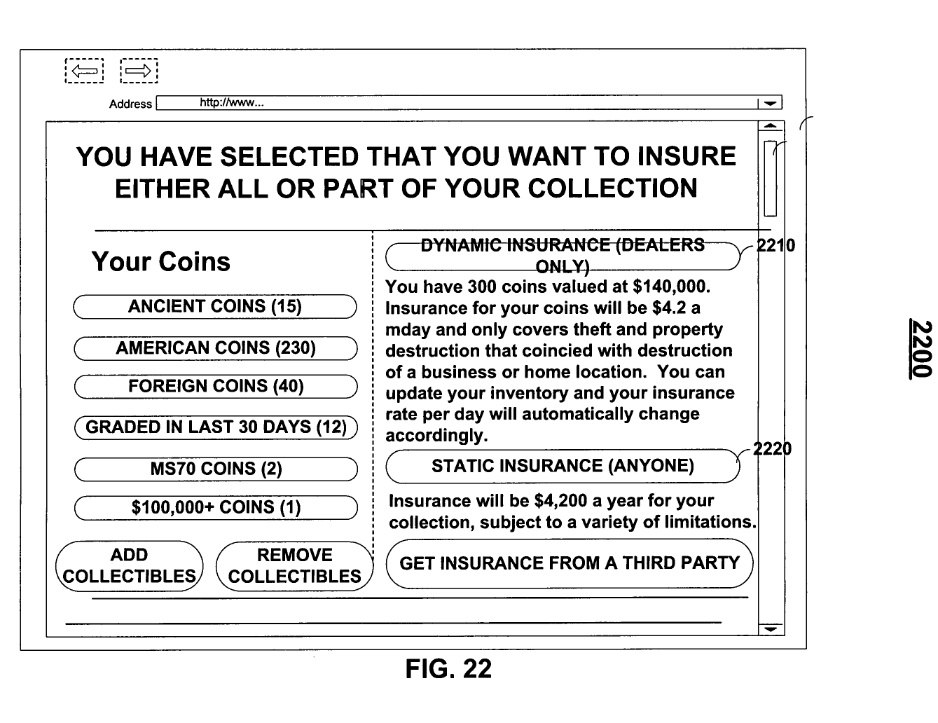

FIG. 22 shows GUI 2200 that provides the ability to insure a collectible or collection of collectibles. Such a collection may be a virtual collection such that a user is offered a button that when pressed provides a quote to insure the collectible for a period of time. By scanning in images of each collectible, the amount of information that can be provided to an insurer about any particular collectible is increased. A user can select a group of collectibles to be insured. The user may be provided with an option for dynamic insurance (e.g., insurance that changes periodically, such as daily, depending on the collectibles in a virtual collection at the start of that period) or statically (e.g., for a year for the collection at the start of the year). Dynamic insurance may be selected by button 2210. Static insurance may be selected by button 2220.

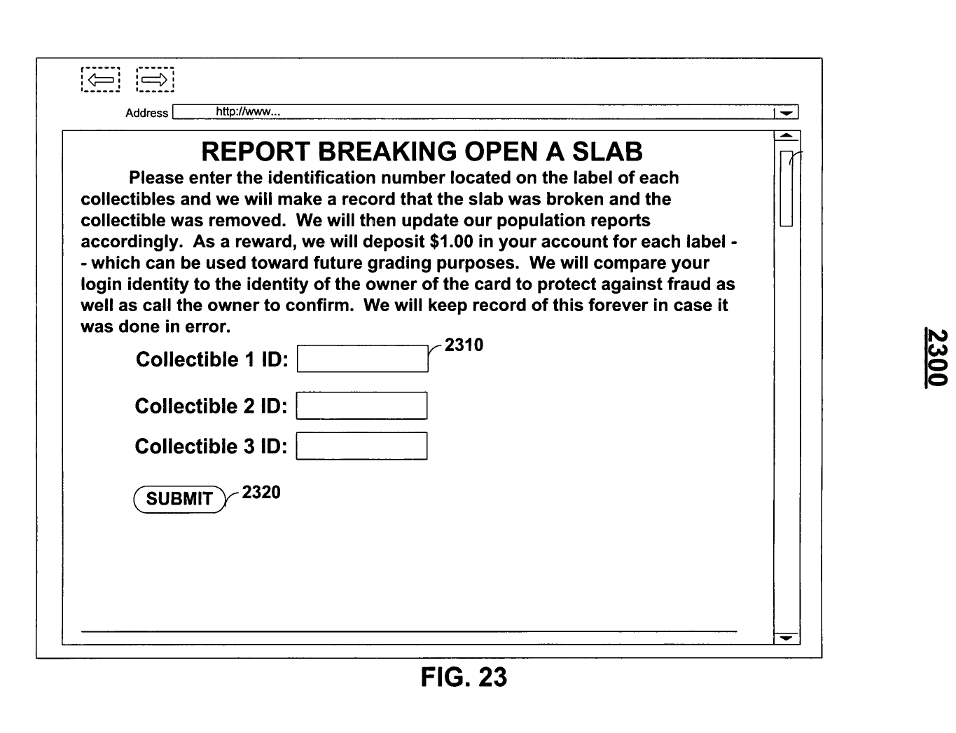

FIG. 23 shows GUI 2300 for reporting a broken slab. For a variety of reasons collectors and/or dealers may occasionally break a collectible out of a slab. GUI 2300 provides an interface for reporting such breaks. Collectors/dealers can be encouraged to report a broken slab with, for example, the offering of a reward (e.g., $1) for each slab reported as being opened. The collector/dealer may be required to send in the label and/or RFID of a slab in addition to reporting it. Rewards may be posted to a user's account so that they can be used towards future purchases. In receiving reports of broken slabs, an entity can provide a more accurate report of, for example, the population of a collectible. For example, information may be entered into text box 2310 and submitted by button 2320 to notify a grading service that a slab has been broken for a specific collectible.

From the foregoing description, persons skilled in the art will recognize that this invention provides a protection device for collectibles. In addition, persons skilled in the art will appreciate that the various configurations described herein may be combined without departing from the present invention. It will also be recognized that the invention may take many forms other than those disclosed in this specification. Accordingly, it is emphasized that the invention is not limited to the disclosed methods, systems and apparatuses, but is intended to include variations to and modifications thereof which are within the spirit of the following claims.

What is claimed is:

1. A system comprising:
a holder encapsulating a collectible and a radio frequency identification tag;
a scanner for reading said radio frequency tag to obtain a collectible identification number; and
a processor for retrieving collectible information associated to said collectible identification number.

2. A method of grading a collectible comprising:
receiving a collectible;
grading the condition of said collectible;
encapsulating said collectible in a collectible holder;
shipping said collectible;
taking a plurality of pictures of said collectible before said shipping;
associating a collectible identification number to a collectible;
associating said plurality of pictures to said collectible identification number; and
storing said plurality of pictures in a memory.

3. A method for generating a webpage for a collectible comprising:
retrieving a collectible identification number from a collectible holder with a scanner;
obtaining information associated to said collectible information number from a memory; and
generating said webpage with said obtained information.

4. The method of claim 3, wherein said scanner retrieves said collectible identification number from a radio frequency identification tag.

5. The method of claim 3, wherein said webpage allows for the purchase of said collectible.

6. The method of claim 3, wherein said webpage allows for the reception of a bid for said collectible.

7. The method of claim 3, wherein said webpage displays location information for finding the collectible at a collectible show.
